(19) United States
(12) Patent Application Publication
(10) Pub. No.: US 2010/0197845 A1
(43) Pub. Date: Aug. 5, 2010

(54) Modified Clays, Method of Obtaining Them, and Applications

(76) Inventors: Bernard Sillion, Lyon (FR); Marie Rastello-de Boisseson, Saint Martin La Plaine (FR)

Correspondence Address: HOFFMANN & BARON, LLP, 6900 JERICHO TURNPIKE, SYOSSET, NY, 11791, US

(21) Appl. No.: 12/223,897

(22) PCT Filed: Feb. 8, 2007
(86) PCT No.: PCT/FR2007/000227

§ 371 Date: Apr. 6, 2010

(30) Foreign Application Priority Data
Feb. 10, 2006 (FR) 0601213
Feb. 10, 2006 (FR) 0601214

(51) Int. Cl. C08K 3/34

(52) U.S. Cl. 524/445

(57) ABSTRACT

The invention relates to modified natural clays made organophilic by means of a polar modifier for increasing their capability of bonding to organic media receiving them, which are composed of natural clays containing, in their structures, monovalent and/or multivalent metal ions and a polar modifier for modifying the surface state of said clays, which is chosen from the group of oligomers having hydrocarbon chains containing carboxylic acid functional groups. The invention is used as organophilic mineral fillers in polymers.

### FIELD OF THE INVENTION

The invention concerns natural clays modified by a polar modifying agent that belongs to a group formed by oligomers with carboxylic acid functions for making these clays hydrophobic.

The invention also concerns a method for transformation of natural clays to organophilic modified clays by means of a polar modifying agent.

Lastly, the invention concerns the use of the natural clays made organophilic in fields as diverse as those of thermoregulation, fireproofing, their use as organophilic mineral filler in polymer media or as organophilic mineral support for organic compounds to be supported.

### BACKGROUND OF THE INVENTION

The natural clays are generally known to belong to the field of mineral fillers comprising for example, calcium carbonate, kaolin, alumina, silica, titanium oxide, talc and others. These mineral fillers are used in numerous fields such as:
coating surfaces to be protected in the fields of building, wood industry, metal industry, by means of paints or some varnishes containing mineral fillers,
coating paper by means of an aqueous suspension, for example, of calcium carbonate, magnesium carbonate, barium sulfate powders,
the introduction of micrometric or nanometric mineral fillers within a thermoplastic or thermosetting matrix with the goal of creating filled polymer materials that have improved properties such as for example, their mechanical, thermal, surface, gas barrier, fireproofing properties, their ability to be painted and this, relative to these same properties of unfilled polymer materials.

These natural clays consequently may be used as mineral fillers in the previously mentioned fields but since they are usually present in the form of lamellar agglomerates, the lamellae of which form stacked leaflets bonded to each other, these lamellar clays should be made organophilic since the proposed field of use is an organic medium such as a polymer.

In addition, for some applications, these clays should be exfoliated to provide mineral fillers of the appropriate size.

To be exfoliated, these lamellar clays that are presented with the appearance of stacks of lamellae, of leaflets or even of superimposed platelets are subjected to an appropriate treatment capable of ensuring their separation from each other to reach the desired state of independent elemental lamellae or leaflets and/or partially disaggregated piles of lamellae or leaflets, such that these lamellae and leaflets so released have a dimension adapted to the receiving medium where these exfoliated clays have to play a role.

Whatever the level of aggregation of clays, they have to be able to be put in contact with, or dispersed uniformly in the receiving medium for which they are designed without repulsion, creation of areas of over-concentration of fillers or areas of under-concentration or even without the appearance of in-situ reagglomeration phenomenon by the absence of compatibility with regard to said receiving medium: especially if the medium is organic, for example, a polymer matrix or a long-chain hydrocarbon.

In other words, the mineral fillers formed by these clays should be able to be accepted by the receiving medium without manifesting rejection: that is why they should be made compatible beforehand with regard to the receiving medium for which they are designed.
Because of this, specific procedures have already been developed to transform the natural clays to organophilic clays by the action of specific modifying agents, such as cationic organic modifying agents, anionic organic modifying agents and amphoteric organic modifying agents.

A first document (U.S. Pat. No. 5,780,376) describes a treatment enabling organophilic clays to be made through organo-onium compounds.

This treatment is carried out in liquid medium and includes a cation exchange between the sodium ions present on the surfaces of the lamellae of clays and a cation to be exchanged from the modifying agent such as ammonium or phosphonium brought by organo-onium compounds. For example, these organo-onium compounds are compounds with formula +NH3R1, +NH2R2R3 or +PR4R5R6R7 in which the radicals R1-R7 are aliphatic hydrocarbon chains with at least four carbon atoms.

But such clay materials that are used in complex treatments are generally used as raw materials with a view to the preparation of nano-fillers.

A second type of treatment enabling natural clays to be made organophilic includes treating these clays by means of a long hydrocarbon chain provided with polar functions combined with a precursor of thermosetting polymer.

Thus, another document (EP 0846661) describes a procedure enabling an organophilic phylosilicate to be obtained that is designed to be exfoliated by contact of the lamellar surfaces of the phylosilicate with an organic compound, with a long carbonaceous compound with at least 6 carbon atoms, this organic compound being functionalized by polar functions of the mono- or polyhydroxyl type, or mono- and polycarboxylic acids and the salts related to them, as well as by polar functions such as aldehydes, ketones, amides, amines or even others.

However, in this type of treatment, which is also designed for exfoliation of a clay, the organic compound functionalized by a polar group such as defined above is not used alone but facilitates the introduction of a second compound to weaken the existing bridges between the leaflets of clay according to the following process:
The organic compound with long alkyl chains that has at least six carbons, and at least a hydroxyl, polyhydroxyl, carboxylic acid or other function, modifies the surface of the clay,
the other compound introduced is an epoxy monomer or polymer,
this co-intercalation being necessary to create a rigid space between two layers of clay and to thus increase the distance between these layers of clay to weaken it and to enable their separation.

### OBJECT OF THE INVENTION

The most important problem posed by the natural clays when one wants to use them in mixture with a medium formed of organic compounds, is that of their compatibility with this medium.

This problem of compatibility has been settled by modifications in their surface state by complex procedures in several steps.

That is why among the fundamental objects assigned to the invention, the creation of organophilic clays may be mentioned by simple single-step modification of their surface state in order to be able to combine them with organic compounds:
by selecting among agents modifying the surface state of said clays organic compounds that combine with said surfaces
by selecting among the organic compounds that combine with the clay surfaces those that will have the most compatible surface energy with the receiving organic medium
by maintaining over time the reinforced coupling ability by modified clays with organic compounds that may be able to be deposited when these clays filled with organic compounds are used in technical fields subjected to mechanical constraints.

### SUMMARY OF THE INVENTION

Consequently, the invention first concerns natural clays modified to make them organophilic and their use in particular in the field of thermoregulating materials or the modification of properties of polymers.

The modified clays:
are obtained by transformation of their surface state by means of an appropriate organic modifying agent with a view to using them once modified as mineral fillers in the field of polymers or organic mineral support for adsorption of organic compounds,
at least partially remove the drawbacks manifested in the state of the art and in addition, bring substantial improvements nonexistent in the means described until today to make them particularly effective in the role that is assigned to them, in particular in applications where mechanical constraints are possibly produced.

According to the invention, the natural clays modified and made organophilic by means of a polar modifying agent of organic origin to increase their ability for coupling with regard to organic receiving media, are characterized in that, according to a new combination, they include:

a) natural clays containing monovalent and/or polyvalent metal ions in their structures,

b) a polar agent for modifying the state of the surface of said clays chosen in the group of oligomers with hydrocarbon chains that have carboxylic acid functions.

The invention also concerns a continuous treatment process of natural clays to be modified to make them organophilic.

Lastly, the invention concerns the use of modified natural clays, made organophilic, as mineral fillers and/or mineral supports with reinforced coupling ability with regard to receiving media organic in origin.

### DETAILED DESCRIPTION OF THE INVENTION

The natural clays modified according to the invention that are designed to become organophilic mineral fillers and/or mineral supports with reinforced coupling ability with regard to organic compounds, are formed from natural clays containing in their structures monovalent and/or polyvalent ions, of a polar agent for modifying the surface state of said clays chosen in the group of oligomers with hydrocarbon chains that have carboxylic acid functions.

According to the invention, the powdery natural clays to be modified are chosen from those that contain in their structure at least one type of monovalent and/or polyvalent metal ions, for example, these ions may belong to the group formed by sodium, potassium, lithium, calcium, magnesium, ferrous iron, ferric iron and aluminum, that are present alone or combined in said clays.

These clays may be preferentially chosen from the groups formed by smectites, chlorites, bentonites, attapulgites, hectorites, laponites, montmorillonites, micas, taken alone or in mixtures.

The modified natural clays are formed from particles with a size from 0.5-10 micrometers and preferentially from 0.5-3 micrometers.

According to the invention, the polar agent for modifying the surface state of said clays is chosen from the oligomers with hydrocarbon chains including carboxylic acid functions, these carboxylic acid functions may be combined with other acid functions such as phosphoric, sulfonic, phosphonic, alone or combined.

These oligomers with hydrocarbon chains forming the polar modifying agent according to the invention are chosen from the polycarboxylic copolymers resulting from the copolymerization of at least one monomer that has at least one carboxylic acid function with an olefin monomer or resulting from grafting of polymers or copolymers with unsaturated monomers containing carboxylic acid functions. These copolymers are oligomers formed of hydrocarbon chains, saturated or unsaturated, preferably linear with carboxylic acid functions, possibly partially esterified.

The polar agent for modifying the surface state of said clays has a polyolefin base that has carboxylic acid functions and is obtained by copolymerization of at least one monomer that has at least one carboxylic acid function with at least an olefin or from olefin polymers that have low molecular weight, functionalized by direct grafting by means of an unsaturated monomer including at least a carboxylic acid function or an anhydride function.

Consequently, the appropriate monomer that according to the invention brings at least one carboxylic acid function by copolymerization or grafting is chosen from the group formed by ethylenic monomers carrying at least one carboxylic acid function chosen from monoacids such as acrylic acid, methacrylic acid, crotonic acid, isocrotonic acid, cinnamic acid, diacids such as itaconic acid, fumaric acid, maleic acid, citraconic acid, the anhydrides of carboxylic acids such as maleic anhydride, itaconic anhydride, citraconic anhydride or any other monomer that has a double bond that is poor in electrons.

It has been observed that these oligomers effectively modified the surface of the clays without any need of adding other organic compounds to them, in contrast to what is disclosed in the prior art.

The polar agent for modifying the surface state of said clays formed by at least one of the above-mentioned copolymers, functionalized by carboxylic acid functions, are oligomers, preferentially with the chain length controlled, in which the molar mass is between 350 g/mol and 5000 g/mol and preferentially between 350 and 2500 g/mol.

The polar agent for modifying the surface state of said clays formed by at least one of the above-mentioned copolymers functionalized by carboxylic acid functions, which are oligomers, preferentially with controlled chain length, have a saponification index between 0 and 220 mg of KOH/g, an acid index between 25 mg of KOH/g and 160 mg of KOH/g and a melting point between 50° C. and 250° C. and preferably between 70° C. and 120° C.

According to the invention, the quantity of powdery natural clays to be modified is between 99.9 and 75 wt % of said modified clays, and the amount of the polar modifying agent is between 0.1 and 25 wt % of said modified clays.

The invention also concerns a method for continuously obtaining modified natural clays by extrusion. This continuous method carried out on industrial scale includes mixing the powdery natural clays and the polar modifying agent to produce modified natural clays with improved properties, the object of the invention.

These modified natural clays are obtained by using a single-screw or double-screw extruder. The best homogenization results are preferentially acquired with corotating double-screw extruders with the extruder used being equipped with heating and cooling systems in the range of the melting and crystallization temperatures of the polar modifying agent chosen.

According to this industrial method for obtaining modified natural clays according to the invention, the introduction of the clay material in the natural state is done in a first extruder barrel through a measuring chute while the polar modifying agent may be introduced either at the same time as the clay in the feeding chute independently in melted form or in the form of granules by means of a pump or a measuring screw.

According to the invention, the method for obtaining modified natural clays includes:
Using the clay in natural state, the structure of which contains monovalent or polyvalent metal ions,
Mechanically putting the polar agent for modifying said clay in intimate contact with said clay mineral support at a temperature higher than that of the melting point of the polar agent for modifying the clay or by introducing the modifying copolymer diluted in paraffin.

Once they are cooled, the modified natural clays are present in the form of a powder that is directly usable for different applications.

The modified natural clays according to the invention may be used in polymers as organophilic mineral fillers, for example for fireproofing, to improve their ability to receive a painting, to make their physical or mechanical characteristics perform better, or even as fillers in the coating industry or may even be used as organophilic supports for organic compounds with phase changes in the field of thermoregulation in the form of coatings of textile supports, fiber coats, coatings for automobile interiors, coatings for rigid panels, components for products designed for building, components for functional packaging, components for products and objects for medical use and comfort of physical persons or support of organic active ingredients.

The examples below illustrate the object of the invention without, however, modifying its scope.

### EXAMPLES

### Example 1

This example concerns obtaining by extrusion a natural clay modified by an oligomer with a low melting point.

The modified clay according to the invention is prepared by extrusion of a composition that comprises 90 wt % of natural clay of the smectite type sold by BENTOFRANCE Company under the name BENTONIL® and 10% of a polar agent for modifying the clay.

The polar agent for modifying the clay is a polymer with carboxylic acid functions sold under the name Ceramer® 1608 by the BAKER PETROLITE Company. This polar agent for modifying the clay has a melting point of 72° C.

The modification of the natural clay by the oligomer Ceramer® 1608 is carried out in a corotating twin-screw extruder of the CLEXTRAL type rotating at 800 rpm.

The powdery clay is introduced at the extruder head by a measuring chute with a flow rate of 18 kg/h and the polar agent for modifying the clay previously liquefied by melting is introduced at the same time with a flow rate of 2 kg/h. The extruder comprises 10 barrels, the first 4 barrels are kept at a temperature of 80° C. in order to keep the polar agent for modifying the clay in a liquid state; then, the last 6 barrels are kept at room temperature. A powder is recovered at the outlet of the extruder.

### Example No. 2

This example concerns obtaining by extrusion natural clay modified by a high melting point oligomer.

The modified clay according to the invention is prepared by extrusion of a composition that comprises 68% natural clay of the smectite type that is sold by BENTOFRANCE under the name BENTONIL® SV, 12% of a polar agent for modifying the clay and 20% paraffin sold under the name LINPAR® 18-20 by the SASOL Company.

The polar agent form modifying the clay is a polymer with carboxylic acid functions sold under the name Unicid® 350 by the BAKER PETROLITE Company. This polar modifying agent has a melting point of 84° C.

Since this polar agent for modifying the clay has a higher melting point than that in Example 1, first, its premixing with the liquid paraffin is carried out, then the natural clay to be modified is added to it.

The extruder used is the corotating twin-screw extruder of Example 1 in which the rotating speed of the screws is set at 500 rpm. The previously liquefied paraffin is introduced at the top of the extruder with a flow rate of 5 kg/h. The Unicid® 350 is introduced into the first barrel kept at 60° C. in the form of small granules with a flow rate of 3 kg/h. The following two barrels are kept at 60° C. in order to carry out the premixing of the polar agent for modifying the clay and the paraffin. The powder clay is added to the fourth barrel at 60° C. with the help of a measuring chute with a flow rate of 17 kg/h. The temperature decreases progressively in the following barrels to ambient temperature. Small granules that are irregular in size are recovered at the outlet of the extruder.

### Example No. 3

This example concerns keeping in suspension in an organic solvent a natural clay modified by a polyacid oligomer with a view to demonstrating the strong hydrophobicizing power of the oligomers of the invention.

Two compositions referenced M1 and M2 have been prepared which contain the paraffin sold under the name LINPAR® 18-20 by the SASOL Company and a natural clay of the smectite type sold by the BENTOFRANCE Company under the name BENTONIL® SV. In the control M1 composition, this clay has not been modified by a modifying agent. On the other hand, in composition M2, the clay has been modified by a modifying agent that is a polymer with carboxylic acid functions sold under the name Ceramer® 1608 by the BAKER PETROLITE Company and used in a procedure described in Example 1.

The proportions of the various compounds in each composition prepared were the following:
Control composition M1 (by way of comparison): 50 wt % of paraffin, 50 wt % of natural clay
Composition M2 according to the invention: 50 wt % of paraffin, 42.5 wt % of natural clay, 7.5 wt % of Ceramer® 1608.

The paraffin that was previously made liquid has been added to the clay for composition M1 and to a premixture heated in the water bath composed of clay and polar agent for modifying the surface state of natural clays for composition M2. After intimate contact for a period of 5 min, each mixture obtained is kept heated in the water bath and then is cooled. The same amount of organic solvent (cyclohexane) has been added in each of these mixtures M1 and M2. The mixtures M1 and M2 are left standing in said solvent for 10 min; then, their condition is observed:
Concerning composition M1, it has been observed that said composition M1 has settled out and has a solid phase including the natural clay with a little paraffin and a supernatant liquid and transparent phase formed of organic solvent and part of the paraffin dissolved in the organic solvent.
Concerning composition M2, in which the powdery natural clay has been modified by the introduction of the polar agent for modifying the clay according to the invention, which is Ceramer® 1608, an absence of settling out is observed, indicating that the polar agent for modifying the clay retained by the clay is performing well for modifying this clay and dispersing it in the organic medium and has completely modified the surface of the clay.

### Example No. 4

This example concerns the greater hydrophobization obtained with the polar agent for modifying the clay, which is the object of the invention, compared to clays modified according to the prior art and compared to a clay modified by a monoacid with low molar mass.

Comparative tests have been carried out with compositions referenced M3, M4, M5 and M6, demonstrating the resistance to extraction by an organic solvent, of physisorbed paraffins on the clay mineral support modified according to the invention.

The two compositions prepared referenced M3 and M4 comprise a paraffin sold under the name LINPAR® 18-20 by the SASOL Company, and as clay in composition M3, a natural clay of the smectite type sold by the BENTOFRANCE Company under the name BENTONIL® sv and in the composition M4, a clay made organophilic that is sold by the Elementis Company under the name BENTONE® 38 VCG. The other two compositions prepared, M5 and M6, comprise the same paraffin sold under the name LINPAR® 18-20 and as clay, the natural clay of the smectite type which, for M5, is modified by a polar agent for modifying the clay, which is a long-chain hydrocarbon organic acid (by way of comparison) and for M6 by a polar agent for modifying the clay, which is a polymer with carboxylic acid functions according to the invention.

The polymer with carboxylic acid functions retained in the composition referenced M6 is Unicid® 350 from BAKER PETROLITE.

The proportions of various compounds in each composition were the following:
Composition M3: 50% paraffin, 50% natural clay
Composition M4: 50% paraffin, 50% commercial organophilic clay
Composition M5: 50% paraffin, 42.5% natural clay, 7.5% hexanoic acid.
Composition M6 according to the invention: 50% paraffin, 42.5% natural clay, 7.5% Unicid® 350.

For compositions M3 and M4, the 50% paraffin previously made liquid are added to the clay. The mixture obtained is heated in the water bath and is cooled after intimate contact for a period of 5 min. Then the same amount of cyclohexane is added to each of these two mixtures and acts as an extraction solvent of the non-attached paraffin.

For compositions M5 and M6, a premixture of clay and polar agent for modifying the surface state of the natural clays is heated in the water bath under stirring. To this mixture is added the 50% paraffin previously made liquid. The resulting mixture obtained after intimate contact for a period of 5 min is then cooled. Then the same amount of cyclohexane is added to each of these two mixtures and acts as an extraction solvent of the unattached paraffin.

After settling and removal of the cyclohexane, the amount of paraffin extracted from each of the four mixtures is measured, leading to the following results (Table 1):

TABLE 1

| | \textcircled{1} Pourcentage de paraffine |
|---|---|
| Composition | extraite au cyclohexane (%) |
| M3 | 93 |
| M4 | 74 |
| M5 | 79 |
| M6 | 68 |

Key:
\textcircled{1} Percentage of paraffin extracted with cyclohexane (%)

The results obtained from extraction show that:
The composition M4 in which the commercial organophilic clay has been modified by quaternary ammonium reveals a decrease in the percentage of paraffin extracted by cyclohexane relative to the control composition M3 prepared from a natural unmodified clay.
The composition M6 in which the powdery natural clay has been modified by the introduction of the polar agent for modifying the clay, Unicid® 350 according to the invention, reveals a very great effectiveness because the percentage of paraffin extracted by cyclohexane appears to be much lower than in all the other compositions.

Thus, it appears that the paraffin is better physisorbed on the clay modified by the polar agent for modifying the clay according to the invention, that is, Unicid® 350.

Consequently, the treatment of the natural clay by polyacid polymers and/or copolymers according to the invention, which are oligomers such as Unicid® 350, increases the ability for physisorption and retention of the paraffin by said modified natural clay and this, in comparison with the same natural clay treated with a monocarboxylic acid and in comparison with a commercial organophilic clay treated with quaternary ammonium, which form reference controls of the prior art.

### Example No. 5

This example concerns the use of polyacid oligomers as a polar agent for modifying natural clays used in the thermoregulating compositions including the natural clay to be modified, the polar agent for modifying clays and the paraffin for phase change.

Three compositions referenced M7, M8 and M9, prepared in the same way, comprise the natural clay, the polar agent for modifying the clay and the paraffin. The first two, M7 and M8, illustrate the object of the invention and the third, M9, forms a reference control.

The polar agent for modifying the clay has been made liquid by heating, then, once melted, added under mixing to the powder clay. The paraffin that has previously been made liquid by heating has been added to this mixture.

Three comparative tests have been conducted, showing the value of using polyacid oligomers for the treatment of natural clays: enthalpy measurements have been carried out on these tests and on the paraffin alone by way of comparison.

The compositions prepared comprised clay, a clay of the smectite type sold by BENTOFRANCE under the name BENTONIL® SV, as paraffin, a paraffin sold under the name LINPAR® 18-20 by SASOL, and as polar agent for modifying natural clays, two different polymers with carboxylic acid functions according to the invention, represented below by the references M7, M8 and by way of comparison a control composition referenced hereafter M9, for which the polar agent for modifying natural clays is an organic acid with a long-chain hydrocarbon.

The first polymer with carboxylic acid function retained in the first composition referenced M7 is Unicid® 350 from BAKER PETROLITE.

The second polymer with carboxylic acid functions retained in the second composition referenced M8 is Ceramer® 1608 from BAKER PETROLITE.

The third composition, which is a control composition and referenced M9, contains hexanoic acid as a polar agent for modifying natural clays.

### Quantitatively:

Composition M7 contains 75% paraffin, 3.75% Unicid® 350 and 21.25% natural clay.
Composition M8 contains 75% paraffin, 2.5% Ceramer® 1608 and 22.5% natural clay.
Composition M9 contains 50% paraffin, 7.5% hexanoic acid and 42.5% natural clay.

Subsequently, the fusion enthalpy is examined by differential calorimetric analysis and is reported per gram of paraffin in the three compositions. The results are reported in Table 2.

TABLE 2

| Composition | \textcircled{1} Enthalpie de fusion (J/g) |
|---|---|
| \textcircled{2} Paraffine seule | 143 |
| M7 | 155.2 |
| M8 | 155.8 |
| M9 | 152 |

Key:
\textcircled{1} Fusion enthalpy(J/g)
\textcircled{2} Paraffin alone

Thus, the paraffin deposited on the clay treated with the modifying agents of said clay has a fusion enthalpy greater than that of paraffin alone, which was completely unexpected.

The compositions M7 and M8 that are objects of the invention have a fusion enthalpy greater than that of the control composition M9. Furthermore, the polyacid oligomer compounds forming the polar agents for modifying natural clays are shown to have an effectiveness greater than that of the monoacid used as the modifying agent in the control composition M9 since less oligomers are needed to have a greater effect.

Additional comparative trials have been conducted showing the value of polyacid oligomers for the treatment of clays in the natural state. These trials demonstrate the resistance to extraction by an organic solvent of physisorbed paraffins on the clay mineral support treated according to the invention.

Three quantitatively identical compositions have been prepared but differ by the polar agents for modifying the clay present. The proportions obtained were the following:
Composition M10 according to the invention: 50% paraffin, 42.5% clay, 7.5% Unicid®350.
Composition M11 according to the invention: 50% paraffin, 42.5% clay, 7.5% Ceramer® 1608.
Control composition M12 (by way of comparison): 50% paraffin, 42.5% clay, 7.5% hexanoic acid.

A premixture of clay and polar agent for modifying the clay was heated in the water bath under stirring. The 50% paraffin was added to this premixture. The resulting mixture obtained was then cooled after intimate contact for a period of 5 min, then the same amount of cyclohexane acting as extraction solvent for the unattached paraffin.

After settling and removal of the cyclohexane, the amount of paraffin extracted from each of the three mixtures was examined, leading to the following results:
Composition M10 according to the invention: 68% paraffin was extracted.
Composition M11 according to the invention: No settling out, which indicates that the paraffin could not be extracted and remained attached to its powder clay mineral support that is modified by the polar agent for modifying the clay,
Control composition M12: 79% paraffin was extracted.

The extraction results obtained show that:
Composition M10 in which the natural powdery clay has been modified by the introduction of the polar agent for modifying the clay, Unicid® 350, reveals a very great effectiveness because the percentage of paraffin extracted by cyclohexane seems much lower than that in the control composition M12.

Thus, the paraffin is better physisorbed on the clay modified by means of the polar agent for modifying the clay according to the invention, that is, Unicid® 350.
Concerning composition M11, in which the natural powdery clay was modified by the introduction of the polar agent for modifying the clay, Ceramer® 1608, it reveals extreme effectiveness since absence of settling out is observed, indicating that the polar agent for modifying the clay retained is performing well in modifying the clay and particularly making it active for physisorption of the paraffin. This example also shows the value of this method for dispersing a natural clay in an organic medium.

Thus, the treatment of natural clay by polyacid polymers and/or copolymers according to the invention, which are oligomers (respectively, Unicid® 350 and Ceramer® 1608), increases the physisorption ability and retention of the paraffin by said clay and this in comparison with the same natural clay treated with a carboxylic monoacid that forms the reference control.

### Example 6

This example concerns obtaining low-density polyethylene containing a clay made organophilic according to the invention and presenting properties of flame resistance as well as improved mechanical properties.

The clays modified according to the invention used in this example are prepared in the same way as in Example 1. The first organophilic clay (AO1) contains 90 wt % of natural smectite clay sold by the BENTOFRANCE Company under the name BENTONIL® SV and 10% of a polar agent for modifying the clay.

The polar agent for modifying the clay is a polymer with carboxylic acid functions, sold under the name Ceramer® 1608 by the BAKER PETROLITE Company. This polar agent for modifying the clay has a melting point of 72° C.

The second organophilic clay (AO2) contains 85 wt % of natural smectite clay sold by the BENTOFRANCE Company under the name BENTONIL® SV and 15% of a polar agent for modifying the clay.

The polar agent for modifying the clay is a polymer with carboxylic acid functions, sold under the name Unicid® 350 by BAKER PETROLITE. This polar agent for modifying the clay has a melting point of 84° C. The modification of the natural clay by a polar agent for modifying the natural clay is carried out in a corotating twin-screw extruder of the CLEXTRAL type turning at 600 rpm.

The powdery clay is introduced at the top of the extruder by a measuring chute with a flow rate of 12.75 kg/h and the polar agent for modifying the clay is introduced simultaneously in the form of small granules through a measuring chute with a flow rate of 2.25 kg/h.

Since the extruder comprises 10 barrels, the first 5 barrels are kept at a temperature of 80° C. in order to keep the polar agent for modifying the clay in the liquid state, then the last 5 barrels are kept at ambient temperature.

A modified clay powder made organophilic according to the invention is recovered at the outlet of the extruder.

As for the preparations of the low-density polyethylene containing the clay previously treated for the purpose of increasing the flame resistance properties and the mechanical properties, it is carried out in a corotating twin-screw extruder of the CLEXTRAL type.

The low-density polyethylene is introduced at the top of the extruder by a measuring chute at a flow rate of 12.75 kg/h and the clay made organophilic AO1 or AO2 is introduced simultaneously with a flow rate of 2.75 kg/h. The extruder barrels are kept at a temperature of 205° C. Then upon exit from the spinneret, granulation in water is carried out. Thus, two compositions M13 and M14 of low-density polyethylene are obtained, one (namely M13) containing the AO1 clay made organophilic and the other (namely M14) the AO2 clay made organophilic.

The composition M13 comprises 85 wt % of low-density polyethylene (hereafter abbreviated PE-BD) and 15% AO1 modified clay.

The composition M14 comprises 90 wt % of low-density polyethylene and 10% AO2 modified clay.

The deflection temperature (Heat Deflection Temperature: HDT) and the oxygen limit index (Limiting Oxygen Index: LOI), indicator of resistance to igniting are measured on the previously defined compositions M13 and M14, and are collected in Table 3 below and compared to results obtained with the same low-density polyethylene that was not treated, M15:

TABLE 3

| | |
|---|---|
| \textcircled{1} Exemples | |
| selon | \textcircled{2} Exemple |
| invention | comparatif |

| | | M13 | M14 | M15 |
|---|---|---|---|---|
| \textcircled{3} | PE-BD | 85 | 90 | 100 |
| Composition | AO1 | 15 | — | — |
| (% poids) | AO2 | — | 10 | — |
| \textcircled{4} Propriétés | HDT (° C.) | 51 | 50 | 45 |
| mécaniques | | | | |
| \textcircled{5} Résistance | LOI (%) | 23 | 22 | 18 |
| à la flamme | | | | |

Key:
\textcircled{1} Examples according to the invention
\textcircled{2} Comparative example
\textcircled{3} Composition (wt %)
\textcircled{4} Mechanical properties
\textcircled{5} Flame resistance

As the results presented in Table 3 show, the compositions M13 and M14 prepared with two clays modified according to the invention have mechanical properties and flame resistance that is better than that of untreated low-density polyethylene, M15.

### Example No. 7

This example concerns obtaining low-density polyethylene containing a clay modified according to the invention that has improved flame resistance properties:

The clay modified according to the invention (AO3) is prepared by extrusion of a composition that comprises 85 wt % of natural clay of the bentonite type sold by the Sud Chemie Company under the name LAUNDROSIL® DGA and 15% of a polar agent for modifying the clay.

The polar agent for modifying the clay is a polymer with carboxylic acid functions, sold under the name Ceramer® 1608 by the BAKER PETROLITE Company. The polar agent for modifying the clay has a melting point at 72° C.

The modification of the natural clay by the oligomer, Ceramer® 1608, is carried out in a corotating twin-screw extruder of the CLEXTRAL type turning at 600 rpm.

The powdery clay is introduced at the head of the extruder by a measuring chute with a flow rate of 12.75 kg/h and the polar agent for modifying the clay is introduced simultaneously in the form of small granules through a measuring chute with a flow rate of 2.25 kg/h.

The extruder comprises 10 barrels, the first 5 barrels are kept at a temperature of 80° C. in order to keep the polar modifying agent in a liquid state; then, the last 5 barrels are kept at ambient temperature.

A modified clay powder made organophilic according to the invention is recovered at the outlet of the extruder.

The low-density polyethylene mixture and clay made organophilic is made in a corotating twin-screw extruder of the Clextral type.

The low-density polyethylene is introduced at the head of the extruder by a measuring chute at a flow rate of 12.75 kg/h and the clay made organophilic (AO3) is introduced simultaneously with a flow rate of 2.75 kg/h. The barrels of the extruder are kept at a temperature of 205° C. Then upon exit from the spinneret, granulation in water is carried out.

The oxygen limit index (Limiting Oxygen Index: LOI) measured on composition M16 which comprises 89.25 wt % of low-density polyethylene, 10% clay made organophilic AO3 and 0.75% antioxidant Irganox, appears in Table 4 below and is compared to that of the untreated low-density polyethylene M15:

TABLE 4

| | | \textcircled{1} Exemple | |
|---|---|---|---|
| | | selon | \textcircled{2} Exemple |
| | | invention | comparatif |
| | | M16 | M15 |
| \textcircled{3} | \textcircled{5} Polyéthylène | 89.25 | 100 |
| Composition | basse | | |
| (% poids) | densité | | |
| | AO3 | 10 | — |
| | \textcircled{6} Antioxydant | 0.75 | — |
| | Irganox | | |
| \textcircled{4} Résistance | LOI (%) | 23.5 | 18 |
| à la flamme | | | |

Key:
\textcircled{1} Example according to the invention
\textcircled{2} Comparative example
\textcircled{3} Composition (wt %)
\textcircled{4} Flame resistance
\textcircled{5} Low-density polyethylene
\textcircled{6} Irganox Antioxidant

According to the results in Table 4, the composition M16 prepared with a clay modified according to the invention has a better flame resistance than the untreated low-density polyethylene, M15.

1. Modified natural clays made organophilic by means of a polar modifying agent to increase their ability for coupling with regard to organic receiving media characterized in that, according to a new combination, they include:
a) natural clays containing monovalent and/or polyvalent metal ions in their structures,
b) a polar agent for modifying the surface state of said clays chosen in the group of oligomers with hydrocarbon chains that have carboxylic acid functions.

2. Modified natural clays according to claim 1, characterized in that the modifying agent is a copolymer in which the acid functions are obtained by grafting at least one unsaturated monomer that has at least one carboxylic acid function.

3. Modified natural clays according to claim 1, characterized in that the modifying agent is an olefinic copolymer that has carboxylic acid functions resulting from the copolymerization of an unsaturated olefinic monomer and at least one unsaturated monomer that has at least one carboxylic acid function.

4. Modified natural clays according to claim 1, characterized in that the modifying agent of said clays has a molar mass between 350 g/mol and 5000 g/mol.

5. Modified natural clays according to claim 1, characterized in that the modifying agent of said clays has a saponification index between 0 and 220 mg of KOH/g.

6. Modified natural clays according to claim 1, characterized in that the modifying agent of said clays has an acid index between 25 mg of KOH/g and 160 mg of KOH/g.

7. Modified natural clays according to claim 1, characterized in that the modifying agent of said clays has a melting point between 50° C. and 250° C. and preferentially between 70° C. and 120° C.

8. Modified natural clays according to claim 1, characterized in that the at least monovalent and/or polyvalent metal ions of natural clays to be modified belong to the group formed by sodium, potassium, lithium, calcium, magnesium, ferrous iron, ferric iron and aluminum, that are present alone or combined in said clays.

9. Modified natural clays according to claim 8, characterized in that the natural clays to be modified are chosen from the group formed by the smectites, chlorites, bentonites, attapulgites, hectorites, laponites, montmorillonites, micas, taken alone or in a mixture.

10. Modified natural clays according to claim 1, characterized in that the natural clays to be modified are formed from particles with a size from 0.5-10 microns and preferentially from 0.5-3 microns.

11. Modified natural clays according to claim 1, characterized in that they comprise 99.9-75 wt % of natural clays and from 0.1-25 wt % of modifying agent relative to the modified natural clays.

12. Method for obtaining natural clays modified by extrusion according to claim 1, characterized in that:
the clay is used in the natural state the structure of which contains monovalent or polyvalent metal ions to be modified in a screw extruder provided with a heating and cooling system and heated to a chosen temperature greater than the melting temperature of the polar modifying agent used alone or in a mixture with paraffin;
extemporaneously or simultaneously mechanically putting the polar agent for modifying said clay in intimate contact with said clay at a temperature higher than that of the melting point of the polar agent for modifying the clay; and
after cooling, a powder that is directly usable for different applications is collected.

13. Use of the modified natural clays according to claim 1 as organophilic mineral fillers in polymers to increase their fireproofing, to improve their ability to receive painting, to make their physical or mechanical characteristics perform better, or even as fillers in the coating industry or even for use as organophilic supports for organic compounds with phase changes in the field of thermoregulation in the form of coatings of textile supports, fiber coats, coatings for automobile interiors, coatings for rigid panels, components for products designed for building, components for functional packaging, components for products and objects for medical use and comfort of physical persons or support of organic active ingredients.
